(19) United States
(12) Patent Application Publication
(10) Pub. No.: US 2007/0260527 A1
(43) Pub. Date: Nov. 8, 2007

(54) Customizing light emitting devices

(75) Inventors: Alexei A. Erchak, Cambridge, MA (US); Udi Meirav, Newton, MA (US)

Correspondence Address: LUMINUS DEVICES , INC.;C/O WOLF, GREENFIELD & SACKS , P.C., 600 ATLANTIC AVENUE, BOSTON, MA, 02210-2206, US

(73) Assignee: Luminus Devices, Inc., Woburn, MA (US)

(21) Appl. No.: 11/430,174

(22) Filed: May 8, 2006

(51) Int. Cl. G06Q 30/00

(52) U.S. Cl. 705/26

(57) ABSTRACT

One aspect of the invention is directed to a method for providing customized light emitting devices. The method includes collecting from a customer at least one technical specification of a light emitting device desired by the customer, obtaining at least one semiconductor wafer suitable for fabricating the light emitting device according to the at least one technical specification, and fabricating the light emitting device from the wafer substantially according to the at least one specification.

### FIELD OF THE INVENTION

The present invention relates to customizing light emitting devices.

### BACKGROUND OF INVENTION

Light emitting devices, such as light emitting diodes (LEDs) and laser diodes, have become increasingly popular and commonplace in today's products. Electronic devices, ranging from televisions to telephones to street signs, for examples, employ light emitting devices. As performance parameters and functionality of such products have improved and the technology employed advanced, the technical specifications of light emitting devices have become more stringent and increasingly important.

To date, no light emitting device design or manufacturing company offers devices that are made according to customer technical specifications. Said differently, no such company performs customization of its light emitting device products according to the technical needs of its customers. Rather, such companies sell predefined lines of products manufactured according to pre-set specifications. One reason for the lack of customization is the limitation of presently available processing technologies which are insufficient to enable companies to cost effectively perform customization. Instead, such companies select lines of products that best suit the marketplace based on available processing technologies. This limitation is a significant drawback in the industry.

### SUMMARY OF INVENTION

Applicants herein have discovered a significant market need for the production of customized light emitting devices. In addition, they have developed technology that enables them to do so cost effectively. The technology includes semiconductor processing technology that enables fabrication of light emitting devices which are highly scalable. It involves in an embodiment a photonic lattice technology.

One aspect of the invention is directed to a method for providing customized light emitting devices. The method includes collecting from a customer at least one technical specification of a light emitting device desired by the customer, obtaining at least one semiconductor wafer suitable for fabricating the light emitting device according to the at least one technical specification, and fabricating the light emitting device from the wafer substantially according to the at least one specification.

In an embodiment, the light emitting device is a light emitting diode.

In another embodiment, the light emitting device is a laser diode.

In another embodiment, the light emitting device is a surface-emitting laser diode.

The technical specification includes one of size, shape, packaging, luminous flux, angular distribution, and output spectrum of the light emitting device.

In an embodiment, the step of fabricating includes forming a photonic lattice that enables uniform surface emission from the light-emitting device.

In another embodiment, the step of fabricating includes forming a photonic lattice that modifies the angular distribution of light intensity.

In another embodiment, the step of fabricating includes dicing along arbitrary directions.

In another embodiment, the step of fabricating includes forming contact geometries that inject electrical current uniformly into the light emitting device.

In another embodiment, the step of fabricating also includes providing at least one heat spreading submount for uniform thermal distribution.

Using these techniques, the light emitting device can be scaled to arbitrary size, shape, packaging, luminous flux, angular distribution, and/or output spectrum of the light emitting device.

In an embodiment, the step of obtaining the wafer includes purchasing the wafer from a wafer supplier.

### BRIEF DESCRIPTION OF DRAWINGS

In the drawing:

FIG. 1 is a flow diagram of a method for providing customized light emitting devices according to the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present invention relates to providing customized light emitting devices. More specifically, the invention relates to fabricating light emitting devices according to technical specifications provided by a customer.

To date, no light emitting device manufacturing company offers light emitting devices that are made according to customer technical specifications. Applicants herein have developed technology that enables them to cost effectively fabricate light emitting devices according to technical specifications provided by a customer.

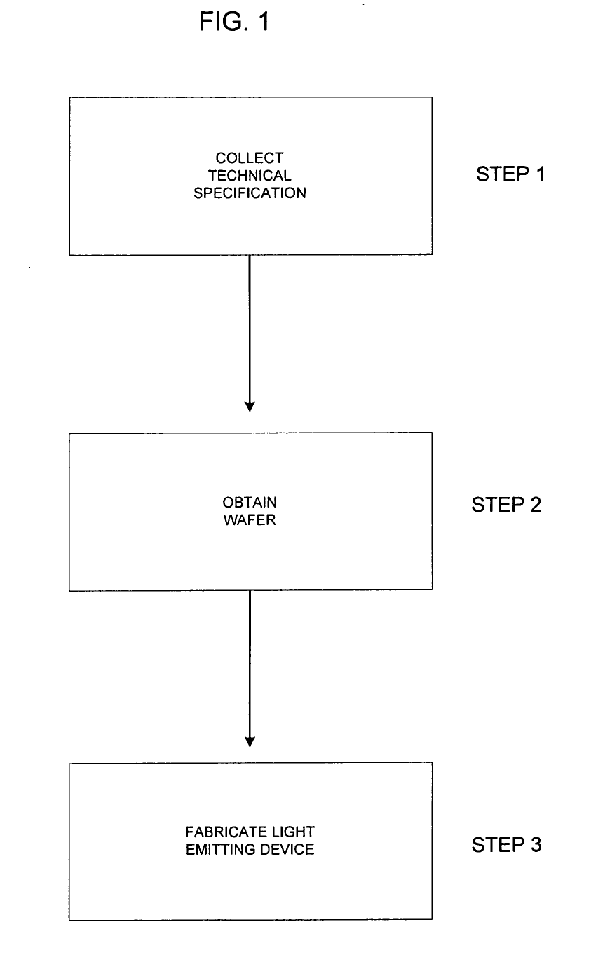

A method of providing customized light emitting devices according to an embodiment of the invention is illustrated in the flow diagram of FIG. 1. In step 1, at least one technical specification of a light emitting device desired by a customer is collected from that customer. The technical specification may relate to at least one of a size, a shape, the packaging, operating power, luminous flux (in lumens/mm², and an output spectrum of the light emitting device. The technical specification is not so limited, however, and may relate to other technical details and/or performance parameters of the light emitting device.

In step 2, a semiconductor wafer, suitable for fabricating the light emitting device according to the technical specification collected in step 1, is obtained. The semiconductor wafer may be purchased or may be grown in-house. Examples of semiconductor wafers include semiconductor wafer sizes with for example 2”, 3”, or 4” diameter, including for example AlInGaN-based materials grown for example on sapphire, SiC, GaN, ZnO, or Si substrates, or for example AlInGaP-based materials grown for example on GaAs substrates. Any method of obtaining a suitable semiconductor wafer is envisioned herein.

In step 3, at least one light emitting device is fabricated from the wafer obtained in step 2, substantially according to the at least one technical specification collected in step 1. The light emitting device may include an LED. Alternatively, the light emitting device may include a laser diode. Alternatively, the light emitting device may include a surface-emitting laser diode. Examples of particular applications for LEDs or laser diodes include, but are not limited to, use in rear projection televisions, use in various lighting applications, use in liquid crystal displays, and various other electronic device lighting applications.

Fabrication of the light emitting device may employ processing technology invented by the Applicants herein. It may, for example, include photonic lattice semiconductor processing technology that enables scalability of the semiconductor wafer. The step of fabricating may also include forming a photonic lattice that enables uniform surface emission from the light-emitting device. The step of fabricating may also include forming a photonic lattice that modifies the angular distribution of light intensity. The step of fabricating may also include dicing along arbitrary directions. The step of fabricating may also include contact geometries that inject electrical current uniformly into the light emitting device. The step of fabricating may also include providing at least one heat spreading submount for uniform thermal distribution. Using these techniques, the light emitting device can be scaled to arbitrary size and shape. This technology is described, for example, in U.S. patent application Ser. No. 10/724,015, Publication No. 2004/0207320, filed Nov. 26, 2004, entitled “Light Emitting Devices,” a copy of which is attached hereto, and which is herein incorporated by reference in its entirety. Such fabrication technology, for example, enables one to cost effectively fabricate a light emitting device according to any size requirement by a customer, without significantly negatively affecting performance.

Another technology that may be employed during fabrication is that also invented by Applicants herein. This technology, which enables one to cost effectively fabricate devices according to any shape requirement by the customer without negatively affecting performance of the light emitting device, is described, for example, in U.S. patent application Ser. No. 10/872,335, Publication No. 2005/0127375, filed Jun. 18, 2004, entitled “Optical Display Systems and Methods,” a copy of which is attached hereto, and which is incorporated herein in its entirety.

Applicants have also developed another related technology that may be employed during fabrication. This technology, which also enables one to cost-effectively fabricate devices according to a packaging or size requirement by the customer without negatively affecting performance of the light emitting device, is described, for example, in U.S. patent application Ser. No. 10/871,877, Publication No. 2005/0051785, filed Jun. 18, 2004, entitled “Electronic Device Contact Structures,” a copy of which is attached hereto, and which is incorporated herein in its entirely.

Further technology, developed by Applicants herein, which enables fabrication of a broader range of high power light emitting devices which reliably operate, is described in U.S. patent application Ser. No. 10/724,033, Publication No. 2004/0207323, filed Nov. 26, 2003, entitled “Light Emitting Devices,” a copy of which is attached hereto , which is herein incorporated by reference in its entirety.

Even further technology, similarly developed by Applicants herein, enables cost-effective fabrication of light emitting devices according to a polarization requirement through the formation of a photonic lattice, is described in U.S. patent application Ser. No. 11/209,905, Publication No. 2006/0043400, filed Aug. 23, 2005, entitled “Polarized Light Emitting Device,” a copy of which is attached hereto, which is herein incorporated by reference in its entirety.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for providing customized light emitting devices comprising:
collecting from a customer at least one technical specification of a light emitting device desired by the customer;
obtaining at least one semiconductor wafer suitable for fabricating a light emitting device according to the technical specification; and
fabricating the light emitting device from the wafer substantially according to the at least one specification.

2. The method as claimed in claim 1, wherein the light emitting device includes a light emitting diode.

3. The method as claimed in claim 1, wherein the light emitting device includes a laser diode.

4. The method as claimed in claim 1, wherein the light emitting device includes a surface-emitting laser diode.

5. The method as claimed in any of claims 1-4, wherein the technical specification includes one of size, shape, packaging, luminous flux, angular distribution of light intensity, a polarization requirement and output spectrum of the light emitting device.

6. The method as claimed in claim 1, wherein the step of fabricating includes forming a photonic lattice that enables uniform surface emission

7. The method as claimed in claim 6, wherein the technical specification includes size.

8. The method as claimed in claim 1, wherein the step of fabricating includes dicing along an arbitrary direction.

9. The method as claimed in claim 8, wherein the technical specification includes shape.

10. The method as claimed in claim 1, wherein the step of obtaining at least one semiconductor wafer includes purchasing the wafer.

11. The method of claim 10 wherein the technical specification includes output spectrum of the light emitting device.

12. The method as claimed in claim 1, wherein the step of fabricating includes forming a photonic lattice.

13. The method of claim 12 wherein the technical specification includes luminous flux.

14. The method of claim 12 wherein the technical specification includes angular distribution of light intensity.

15. The method of claim 12 wherein the technical specification includes a polarization requirement.

16. The method as claimed in claim 1, wherein the step of fabricating includes forming contact geometries that enable uniform electrical current injection into the light emitting device.

17. The method of claim 16 wherein the technical specification includes size.

18. The method of claim 16 wherein the technical specification includes shape.

19. The method as claimed in claim 1, wherein the step of fabricating includes forming a heat spreader that enables uniform thermal distribution.

20. The method of claim 19 wherein the technical specification includes size.

21. The method of claim 19 wherein the technical specification includes packaging.

22. The method of claim 19, wherein the technical specification includes various ranges of operating powers.
